(19) United States
(12) Patent Application Publication
(10) Pub. No.: US 2011/0187707 A1
(43) Pub. Date: Aug. 4, 2011

(54) SYSTEM AND METHOD FOR VIRTUALLY AUGMENTED ENDOSCOPY

(75) Inventors: Arie Kaufman, Plainview, NY (US); Joseph Marino, Pt. Jefferson Station, NY (US)

(73) Assignee: THE RESEARCH FOUNDATION OF STATE UNIVERSITY OF NEW YORK, STONY BOOK (NY)

(21) Appl. No.: 12/867,424

(22) PCT Filed: Feb. 13, 2009
(86) PCT No.: PCT/US09/34104

§ 371 Date: Apr. 1, 2011

(30) Foreign Application Priority Data
Feb. 15, 2008 (US) 61/029078

(51) Int. Cl. G06T 15/00

(52) U.S. Cl. 345/419

(57) ABSTRACT

Virtually augmented endoscopy includes overlaying optical endoscopy image data with a virtual endoscopy model. Image distortion in the optical endoscopy image data can be substantially reduced. Features in the virtual endoscopy model can be correlated with features in the optical endoscopy image data to improve examination performance. A correlation path through the virtual endoscopy model can be determined that reasonably follows the physical path of an endoscope. A 2D or 3D correlation model can be generated from the image data and correlated to the virtual endoscopy model. Correlation between the scan data domain and the image data domain can use either the correlation path, correlation model or a combination thereof. CAD tools and other features of virtual endoscopy can then be applied to enhance the performance of optical endoscopy.

### STATEMENT OF PRIORITY AND RELATED APPLICATIONS

This application claims priority to U.S. Provisional Application 61/029,078 filed on Feb. 15, 2008, entitled Method and Apparatus of Virtually Augmented Endoscopy, which is hereby incorporated by reference in its entirety.

### STATEMENT OF GOVERNMENT RIGHTS

This work has been supported, at least in part, by NSF grant CCR-00702699 and NIH grants CA082402 and CA11018601. The United States government may have certain rights to the invention described and claimed herein.

### BACKGROUND

Many diseases are diagnosed and treated using endoscopes, such as colorectal cancer. Colorectal cancer is the second leading cause of cancer-related deaths in the United States. Most colorectal cancers are believed to arise within benign adenomatous polyps that develop slowly over the course of many years. Accepted guidelines recommend the screening of adults who are at average risk for colorectal cancer, since the detection and removal of adenomas has been shown to reduce the incidence of cancer and cancer-related mortality. Some researchers have advocated screening programs to detect polyps with a diameter of less than one centimeter. Unfortunately, most people do not follow this advice because of the discomfort and inconvenience of the traditional optical colonoscopy. To encourage people to participate in screening programs, virtual colonoscopy (VC) has been proposed and developed to detect colorectal neoplasms by using a computed tomography (CT) or MRI scan. Virtual colonoscopy is minimally invasive and does not require sedation or the insertion of a colonoscope. Virtual colonoscopy exploits computers to reconstruct a 3D model of the CT scans taken of the patient's abdomen, and create a virtual fly through of the colon to help radiologists navigate the model and make an accurate and efficient diagnosis.

It has been demonstrated that the performance of a virtual colonoscopy compares favorably with that of a traditional optical colonoscopy (“OC”). However, even with technological strides being made towards fighting colorectal cancer, there has been reluctance among some doctors and insurance companies to adopt the use of the VC technology that has been developed. It has been demonstrated, however, that traditional optical colonoscopy is unable to obtain the same coverage of the colon lumen as VC, with OC missing approximately 23% of the colon surface, while a standard VC examination may miss only about 9% of the surface. Tools built into a VC system, combined with computer aided diagnostic (CAD) techniques, could allow for greater coverage of the colon surface, up to 100% coverage. On the other hand, OC does present some advantages over VC, in that the doctor is able to observe the actual color of the colon walls, as well as any blood vessels or other features on the colon surface. In addition, during OC, a doctor can perform polypectomy, if necessary. From this comes the need for a system that can merge the information from the VC into the OC procedure, allowing gastroenterologists to leverage the advantages of both techniques. Such a system could allow for a more efficient and accurate inspection of the colon by doctors searching for colonic polyps.

### SUMMARY

A method of virtually augmented endoscopy includes receiving scan data of a region. From the scan data, a virtual representation of at least a portion of a lumen within the region can be generated. Optical endoscopy image data from within said lumen is also received and a correlation is generated between the image data and the scan data of the region. An image generated from the image data is displayed in correlation with the virtual representation of the lumen.

The correlation generated can include a correlation path generated in the virtual lumen. The correlation generated can also include a correlation model, such as a shape from feature model that is generated from the image data which can be correlated to the virtual representation of the lumen.

A system for virtually enhanced endoscopy includes an interface for receiving scan data of a region, an interface receiving optical image data of a region, a processor, and a graphical user interface. The processor is configured to process the scan data and generate a virtual representation of at least a portion of a lumen within the region from the scan data. The processor is further configured to receive the optical image data of a region and correlate the optical image data and the scan data. The graphical user interface includes a display and receives display data from the processor for generating a first image from the image data in correlation with a second image from the virtual representation of the lumen.

The present virtually enhanced endoscopy system and methods further provide for correlating CAD and user findings with the virtual representation and image data of the lumen. For example, a number of displays or display windows can be provided in which at least a first display window displays an image generated from the image data, and at least a second window displays an image generated from a computer aided diagnostic procedure for a region corresponding to the image generated from the image data. The enhanced endoscopy system and methods can also perform computer aided diagnostics on the scan data to generate a list of suspicious regions, track the regions displayed in the image data, and identify suspicious regions on the list that were not displayed or otherwise presented to the user. The systems and methods can be applied to live endoscopy data or stored endoscopy data, such as video data of a previous procedure. When used with live endoscopy data, the virtually augmented endoscopy system can provide an indication to a user to manipulate an endoscope to view an unviewed region. When a region cannot be viewed in either live or stored image data, the region can be presented to the user in the virtual representation of the lumen.

### BRIEF DESCRIPTION OF THE DRAWINGS

FIG. 1 is a flow chart illustrating an overview of the present process for performing virtually augmented endoscopy;

FIG. 2 is a simplified block diagram of a system suitable for performing virtually augmented endoscopy;

FIGS. 3A and 3B are simplified cross-sectional views of a portion of a curved lumen illustrating a true centerline (FIG. 3A) and a hugging corner, shortest path (FIG. 3B) through the lumen, which is more typical of a physical endoscope path;

FIG. 4 is a simplified diagram of the face of an example of an endoscope head, illustrating a typical position of a lens with respect to the endoscope head;

FIG. 5A illustrates a reference pattern (checkerboard) acquired with a fish-eye lens;

FIG. 5B illustrates the image of FIG. 5A after being subjected to a correction process to provide radial undistortion;

FIG. 6 is a simplified diagram illustrating exemplary features of optical endoscopy and virtual endoscopy that can be combined in a virtually enhanced endoscopy system using a graphical user interface; and

FIG. 7 is an illustration of an exemplary screen of a graphical user interface for use in a virtually enhanced endoscopy system.

### DETAILED DESCRIPTION

In general, the present disclosure is directed to virtually augmented reality of optical endoscopy. This entails the convergence of virtual endoscopy in cooperation with conventional optical endoscopy in order to improve the overall performance that can be achieved using either approach independently.

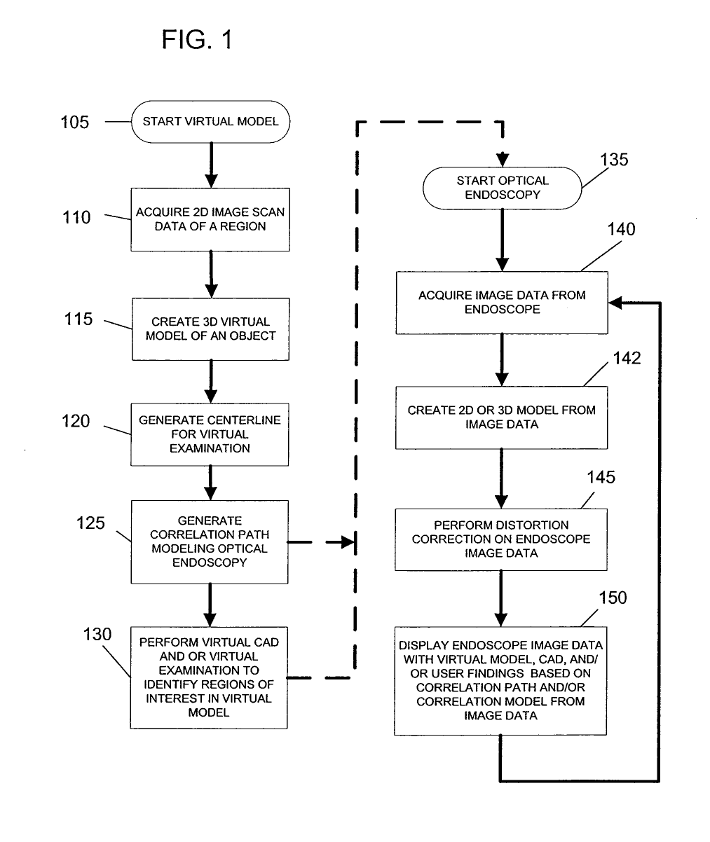

FIG. 1 is a simplified flow chart illustrating the basic operation of the present method of virtually assisted endoscopy. The process is generally explained using colonoscopy as an example, but it is understood that the process may be applied to the examination of a wide range of luminal structures in which an endoscope can be inserted. Initially, a virtual model of a region of interest is generated based on two-dimensional image data. This process typically begins with preparation of the region followed by image data acquisition, such as computed tomographic (CT) or magnetic resonance imaging (MRI) scan data (step 110). From the acquired 2D image data, a 3D virtual model is generated (step 115). Preferably, a centerline through the virtual model is also generated (step 120). Previously known systems and methods for patient preparation, acquiring image scan data and generating a virtual model can be applied to perform steps 105 through 120. For example, suitable techniques are described in U.S. Pat. Nos. 5,971,767, 6,331,116 and 6,514,082, the disclosures of which are incorporated by reference in their entireties.

In addition to generating a centerline through the virtual model of the lumen, which in typical virtual colonoscopy is intended to closely match a true centerline through the lumen, it is also desirable to generate a separate correlation path that more closely follows the expected path that will be traveled by a physical endoscope (step 125), such as the “hugging corner shortest path” described more fully below. The user can perform a virtual endoscopy procedure and record his findings (step 130). Further, after the generation of the virtual model, it is desirable to apply computer aided diagnostic (CAD) techniques to identify suspicious regions, such as polyps (step 130). Known techniques for CAD which are applicable to the present method are described for example in International Published Application, WO/2007/002146 (and corresponding U.S. patent application Ser. No. 11/993,180) entitled System and Method of Computer Aided Polyp Detection, which is hereby incorporated by reference in its entirety. It will be appreciated that other CAD techniques which suitably identify suspicious regions of an object may also be used. In addition to the 3D model of the lumen, the virtual endoscopy model can also include 2D images and a flattened model of the lumen interior, which are known in the art.

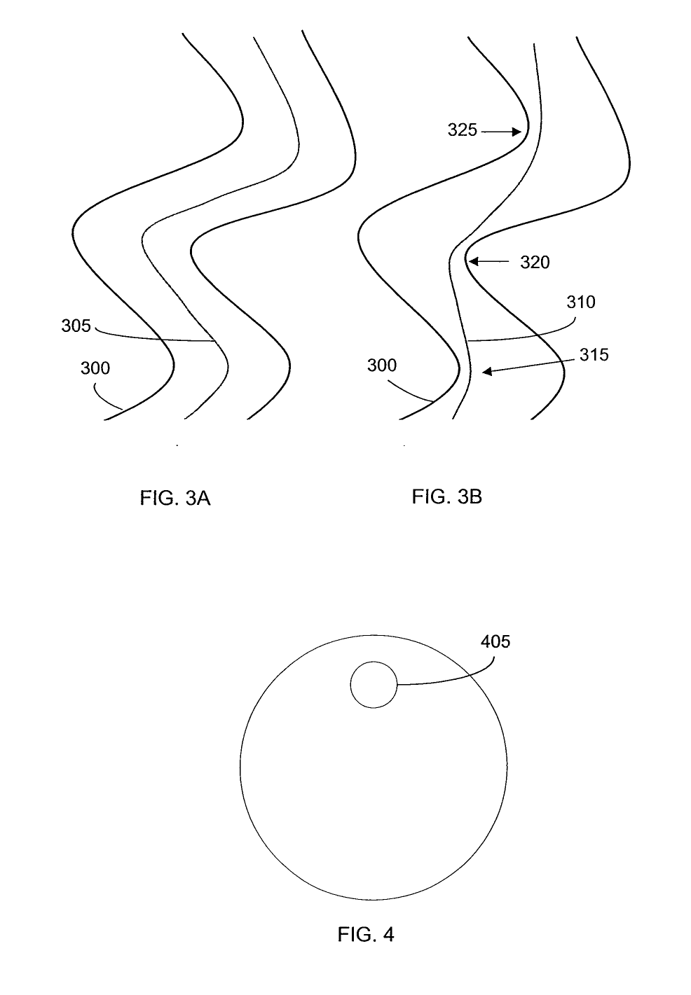

FIG. 3A is an illustration of a typical centerline generated in virtual lumen models, such as those used in connection with virtual colonoscopy. In FIG. 3A, the centerline 305 is substantially centered within the lumen walls 300. Although such a model has benefits in connection with virtual fly-paths, such a centerline does not accurately reflect the path that will be taken by an endoscope as it traverses a lumen, such as the colon. Rather than following a theoretical centerline, it has been observed that physical endoscopes more typically follow a “hugging corner shortest path” through the lumen, as depicted by path 310 in the diagram of FIG. 3B. In FIG. 3B, it can be observed that the path 310 is no longer centered throughout the length of the lumen, but favors a corner hugging path at regions with significant turns in the lumen, such as regions 315, 320, and 325. Thus, in addition to generating a true centerline 305 for the lumen in the virtual model, in order to better correlate the virtual model with an expected physical path of an endoscope, it is desirable to calculate an additional correlation path that is based on the “hugging corner shortest path,” such as path 310 (FIG. 3B).

FIG. 4 is a diagram that illustrates an example of a typical endoscope head 400 and shows a typical location of a lens 405 on the distal end of a colonoscope (other items typically located on the distal end are not shown). Because in most conventional endoscopes, the lens 405 is not directly on the edge of the distal end of the endoscope, the hugging corner shortest path with respect to the lens center will generally remain some minimum distance from the colon wall, as illustrated in FIG. 3B at regions 315, 320 and 325. In the case of an Olympus Model CF-Q160L colonoscope, this distance can range from about 2.8 mm to about 10 mm, depending on how the colonoscope is oriented with respect to the colon wall, with the average distance being approximately 6.4 mm.

The centerline 305 and hugging corner shortest path 310 can both be represented as spline curves, and can be discretized into a certain number of points for display and visualization. Knowing a distance that a colonoscope is inserted, the discrete point for that location on the shortest path can be calculated. The endoscopes include depth markings that can be entered by the user to provide approximate insertion depth information. The distance along the centerline 305 is correlated to the shortest path 320 so that any point along the centerline 305 in the VC can be matched to a point on the correlation path 310 in the simulated OC (and vice versa). During an endoscopic procedure, the exact path of the physical colonoscope is generally not known. Thus, in the present methods the actual endoscope path is estimated and correlated to the centerline 305 calculated for VC. The distance from the rectum along the path can then be matched to a point on the VC centerline.

After a virtual model is generated, conventional optical endoscopy can be performed, starting at step 135. Typical endoscopes, such as Olympus Model CF-Q160L colonoscope, acquire optical video image data using a digital sensor such as a CCD array and provide that data in digital format. In the alternative, analog image data can be acquired and digitized for further processing (step 140). United States published patent application Ser. No. 11/586,761, publication number 2007-0161854, published on Jul. 12, 2007 and entitled “System and Method for Endoscopic Measurement and Mapping of Internal Organs, Tumors, and Other Objects,” describes suitable techniques for processing endoscopy video data, and is hereby incorporated by reference in its entirety. In particular, this published application discloses a “shape from motion” process, a “shape from shading process” and the combination of these features that that can be used to generate 2D and 3D models from the optical endoscopy video images (step 142). These models can be used to identify features and landmarks in the lumen that can be used to correlate with corresponding features in the virtual endoscopy model.

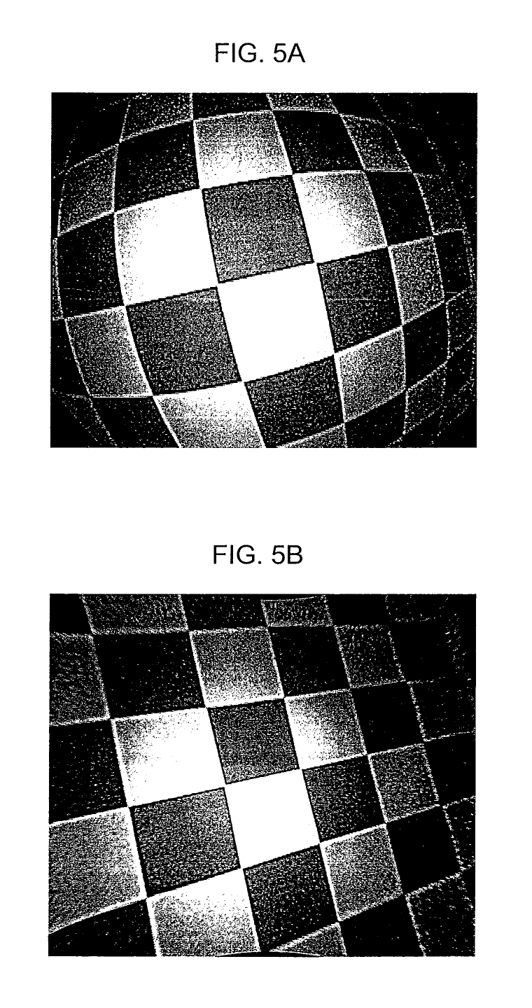

It is typical for an endoscope to employ a fish-eye type lens in order to obtain a wide field of view within a lumen. In this case, as illustrated in FIG. 5A, the image acquired by the endoscope will generally suffer from significant radial distortion introduced by the lens. The radial distortion can be significantly reduced (see FIG. 5B) through suitable processing (step 145) which is described in greater detail below.

As the endoscope is inserted and traverses the lumen, the length of insertion is monitored and the position of the endoscope head can be correlated with the virtual model by way of the previously defined correlation path 310 defined in the virtual model (step 150). Another method of correlating the virtual model and optical image data is to correlate the virtual model and the 2D or 3D model from the image data developed in step 142. These two correlation techniques can be used individually or together. Steps 140-150 are dynamically repeated during the course of optical endoscopy procedure as the endoscope head is repositioned within the lumen or during the course of review of endoscopic video image data previously acquired.

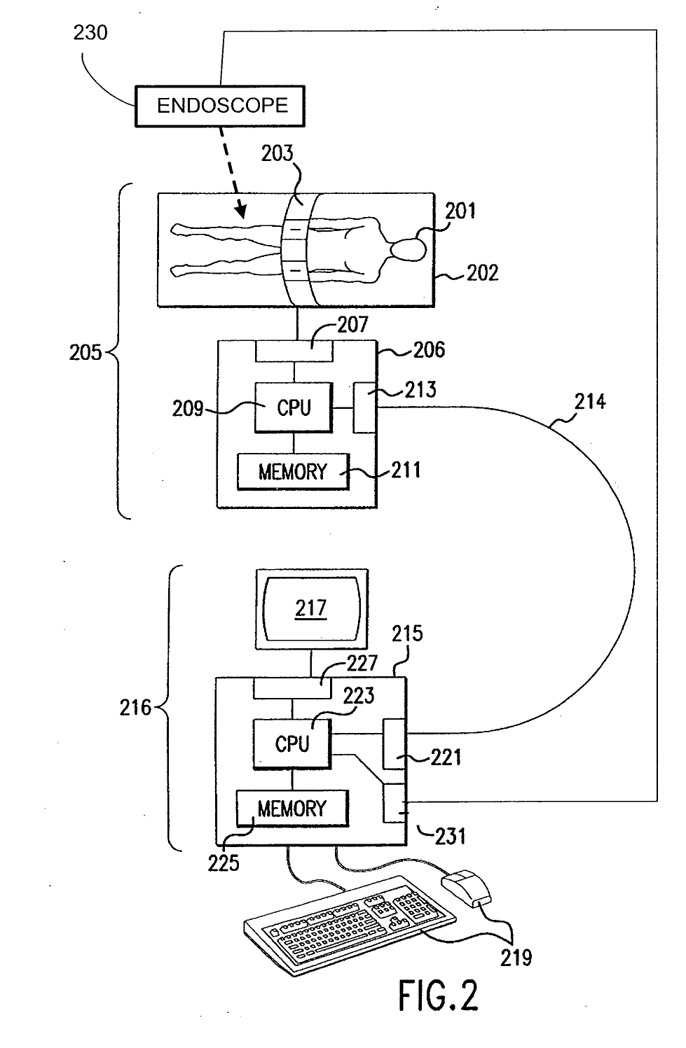

FIG. 2 is a block diagram that illustrates a system for performing virtually assisted endoscopy of an object such as a human organ, using the techniques described in this specification. Patient 2 typically lies down on a platform 2 while scanning device 205 scans the area that contains the organ or organs which are to be examined. (See step 110, FIG. 1) The scanning device 205 contains a scanning portion 203 which actually acquires images of the patient and an electronics portion 206. Electronics portion 206 includes an interface 207, a central processing unit 209, a memory 211 for temporarily storing the scanning data, and a second interface 213 for sending data to the virtual navigation platform. Interface 207 and interface 213 could be included in a single interface component or could be the same component. The components in portion 206 are generally interconnected with conventional connectors.

In system 200, the data provided from the scanning portion of device 203 is transferred to portion 205 for processing and is stored in memory 211. Central processing unit 209 converts the scanned 2D data to 3D voxel data and stores the results in another portion of memory 211. Alternatively, the converted data could be directly sent to interface unit 213 to be transferred to the terminal 216. The conversion of the 2D data could also take place at the virtual navigation terminal 216 after being transmitted from interface 213. In one embodiment, the converted data is transmitted over carrier 214 to the terminal 216 in order for an operator to perform the virtual examination. The data could also be transported in other conventional ways such as storing the data on a storage medium and physically transporting it to terminal 216 or by using satellite transmissions.

The scanned data need not be converted to its 3D representation until the visualization rendering engine requires it to be in 3D form. This can save computational steps and memory storage space.

Terminal 216 includes a screen for viewing the virtual organ or other scanned image, an electronics portion 215 and interface control 219 such as a keyboard, mouse or track-ball. Electronics portion 215 comprises a interface port 221, a central processing unit 223, other components 227 necessary to run the terminal and a memory 225. The components in terminal 216 are typically connected together with conventional connectors. The converted voxel data is received in interface port 221 and stored in memory 225. The central processor unit 223 then assembles the 3D voxels into a virtual representation and runs a submarine camera model to perform the virtual examination. A graphics accelerator can also be used in generating the representations. The operator can use interface device 219 to indicate which portion of the scanned body is desired to be explored. The interface device 219 can further be used to control and move the virtual camera within the virtual lumen model. Terminal portion 215 can include a high speed graphics processor station, such as Cube-4, Volume Pro or other graphical processing unit. A system for performing such a virtual examination is more thoroughly described in U.S. Pat. No. 5,971,767, the disclosures of which are incorporated by reference in its entirety.

A conventional endoscope 230, such as Olympus Model CF-Q160L colonoscope, can be used to acquire optical image data from within a lumen during an examination of a region of interest. The image data from the endoscope 230 can be provided to the system 200 via a conventional digital input/output interface 231 which is coupled to the CPU 223. It will be appreciated that while FIG. 2 illustrates a single terminal 216, the functions described for terminal 216 could be divided among two or more terminals.

The above described techniques can be further enhanced in virtual colonoscopy applications through the use of electronic colon cleansing techniques which employ bowel preparation operations followed by image segmentation operations, such that fluid and stool remaining in the colon during a computed tomographic (CT) or magnetic resonance imaging (MRI) scan can be detected and removed from the virtual colonoscopy images. Through the use of such techniques, conventional physical washing of the colon, and its associated inconvenience and discomfort, can be minimized. Such techniques are described, for example, in U.S. Pat. No. 6,331,116, which is hereby incorporated by reference in its entirety.

Typically, endoscopes acquire images using a fish-eye lens. For example, the Olympus colonoscope described above includes a fish-eye lens with a field of view of 140 degrees. The fish-eye lens provides an advantage in that the field of view is substantial. A disadvantage, however, is that such a lens introduces significant radial distortion that can make it difficult to accurately assess the actual size and shape of an item being observed. Since decisions on whether an item on the colon wall is a polyp or not is heavily dependent on size and shape characteristics, such radical distortion is undesirable. Correction of these images by a process of radial undistortion is expected to generally yield a more normal perspective view, in which the size and shape information from the inside of a lumen being evaluated will be more correctly presented. This can provide an improvement in the gastroenterologist's ability to correctly identify abnormalities, such as potentially cancerous polyps.

### Radial Undistortion

The radial distortion from the fish-eye lens can be represented mathematically using an infinite series, with the distortion then calculated using the equation:

F(r)=rf(r)=r(1+k₁r²+k₂r⁴+k₃r⁶+ . . . ),

where r²=x²+y², with (x, y) being the normalized undistorted projected points in the image frame, and kₙ are the scalar distortion coefficients. The distorted coordinates in the camera frame can then be calculated as:

p_{d}=pᵤ·f(r),

where pᵤ are the undistorted coordinates (xᵤ, yᵤ) and p_{d} are the distorted coordinates (x_{d}, y_{d}) in the camera frame. Since the image space, where the work will be performed, contains noise, modeling the distortion above the second distortion coefficient tends not to improve the results, so the distortion can be modeled as:

f(r)=1+k₁r²+k₂r⁴.

It has also been found that the r values can be reduced, such that the distortion can now be modeled more simply as:

f(r)=1+k₁r+k₂r².

Using this simplified model, the edges of the undistorted image are less prone to distortion artifacts from the image inverting back in on itself.

When working in the image space, as opposed to the space of the camera frame, it may be desirable to calculate the distortion in the (u, v) space of the image, rather than in the (x, y) space of the camera frame. The distortion in the image (u, v) space can be calculated as:

u_{d}−u₀=(u−u₀)f(r),

v_{d}−v₀=(v−v₀)f(r),

where (u, v) are the image coordinates of the original undistorted image point, (u_{d}, v_{d}) are the coordinates of the corresponding distorted image point, and (u₀, v₀) are the coordinates of the image center. The adjustment using the image center coordinates is necessary to ensure that the radial distortion occurs around the center of the image, since the (x, y) coordinates of the pixels will be in the range [1, width] for x and [1, height] for y, with the center point being at (width/2, height/2). In the camera frame, the coordinates (0, 0) are at the center, with the values for x in the range [−x, x] and the values for y in the range [−y, y], and hence no adjustment would be necessary.

In calculating the distortion, the value of r, used in the equation for f(r) (Equation 4) can be calculated. Since r²=x²+y², this value is preferably calculated in the 2D projection space of the camera frame, rather than in the image space. This can be accomplished using the affine transformations:

$$x = \frac{u - {u}_{0}}{{m}_{u}} , \\ y = \frac{v - {v}_{0}}{{m}_{v}} , \qquad ( 6 )$$

where mᵤ and mᵥ are the number of pixels per unit distance in the u and v direction, obtained from our previous work in colonoscope calibration.

The radial undistortion process is preferably performed on the graphics processing unit (GPU), using the coordinates of the framebuffer as the output for the undistorted image. Because of this, the radial undistortion problem can be thought of as knowing each pixel location on the undistorted image, and from there calculating where on the distorted input image to obtain the color value from. Using this method, the values for (x, y) in Equation 6 can be calculated. Likewise, the distorted pixel locations (u_{d}, v_{d}) can be calculated using Equation 5 as follows:

u_{d}=(u−u₀)f(r)+u₀,

v_{d}=(v−v₀)f(r)+v₀.

The undistorted image formed is larger than the original, distorted image, as the undisortion process pushes the image information past the boundaries in the distorted image. Rather than locking the scalar distortion coefficient values for k₁ and k₂ to specific values or necessitating individual colonoscopes to be calibrated before use to obtain these values, a simple interface can be provided with two controls, such as thumbwheels, to allow for easy adjustment of the two values. Since barrel distortion (the type of radial distortion present in colonoscopes) occurs when the value of k<0, the controls should preferably be adjusted to negative values to perform the undistortion process.

### Path Correlation and Model Correlation

To overlay an optical endoscopy image on a virtual lumen model, the two image sets can be correlated based on a common correlation path through the lumen. In addition to the centerline 300 that is typically calculated for VC, in the present case it is also beneficial to calculate a hugging corner shortest path as a correlation path 310. This path more closely approximates the actual path traveled by a physical colonoscope as it is moved through a patient's colon.

In performing path correlation, it is an objective that for each point on one path, a corresponding point on the other path can be found such that the views inside the colon generated from both of these points should be similar. For this process, simply finding the nearest point on the other path may not be an appropriate solution, as the bends in the paths might make a physically closer point further away from the area of interest. Rather, it is desirable to find matching points that are in the same cross section of the colon lumen.

Since the centerline 300 follows the contours of the colon more closely than the shortest path, it is a preferred path to use as the starting point in calculating the correlation. The normalized direction of the centerline at a point x is obtained using the next and previous points on the centerline. To ensure a smooth curve for this calculation, several points before and after x are averaged and used to calculate the direction vector. This normalized direction vector is then taken to be the normal of a plane that is perpendicular to point x. Since the centerline closely follows the contours of the colon, this plane can be said to approximate the cross section of the colon which contains point x. The nearest point to x on the shortest path is then found, which is within some tolerance of being on the plane. This pointy on the shortest path is then also in the same cross section as point x. Since they are in the same cross section, points x and y can be considered correlated.

In addition to correlation based on the hugging corner shortest path, it is also desirable to correlate the virtual model derived from the scan data with the 2D or 3D model generated from the image data, such as the shape from feature model described above. For example, in the case of colonoscopy, the image data can be acquired starting at the secum and the shape from feature model can be incrementally correlated with the virtual model based on the secum location in this model and proceeding along the lumen to a known endpoint, such as the rectum. It is noted that absolute registration between the scan data and the image data is not required so long as the correlation allows the user to generally observe approximately the same region in the two data sets.

### Augmented Reality Endoscopy

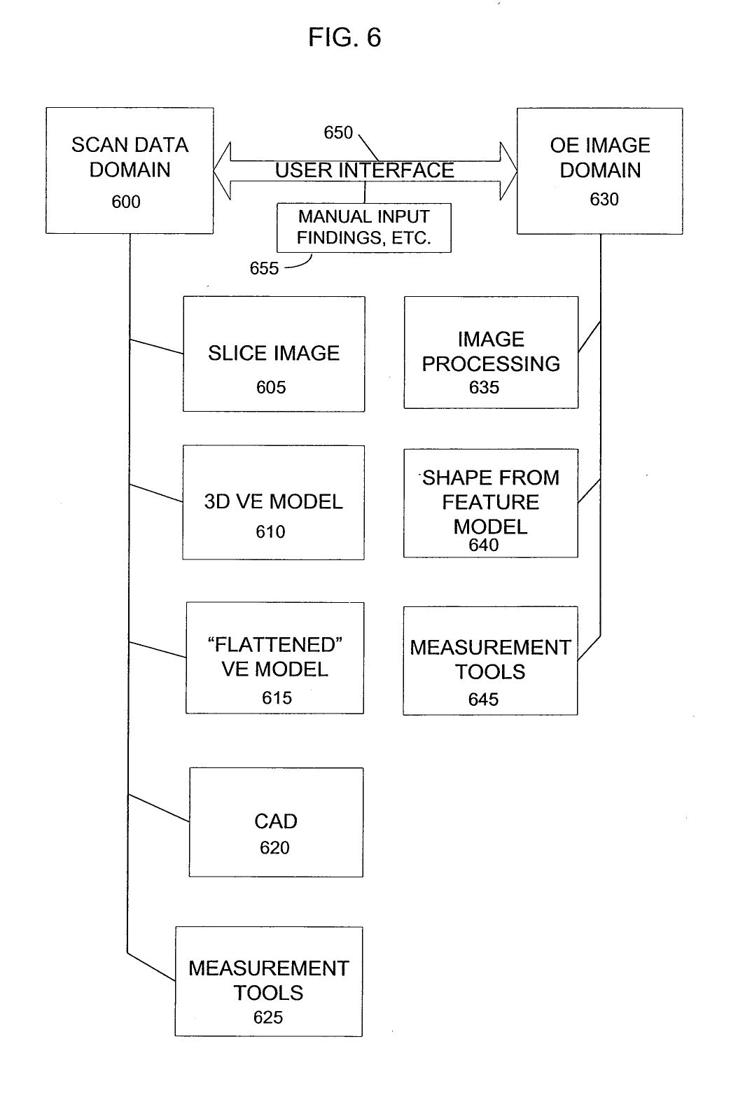

With the virtual endoscopy and optical endoscopy data correlated, the advantages of virtual endoscopy can be applied to improve the performance of optical colonoscopy procedures and create an enhanced feature set. FIG. 6 illustrates some of the features of virtual endoscopy and optical endoscopy that can be cooperatively used in a graphical user interface 650 to obtain a virtually enhanced endoscopy system. In virtual endoscopy, scan data 600, such as CT data is acquired and is used to create various virtual tools in the scan data domain. In a virtual endoscopy system, a user can view conventional slice images 605 at a selected point of the lumen. In addition, a 3D virtual model of the lumen 610 can be generated. Using the 3D model, a user can navigate through the lumen, such as by auto-navigating or performing a guided navigation along a center line or via manual navigation through the lumen. This provides a virtual simulation of optical endoscopy. Further, the virtual endoscopy tools allow a flattened lumen model 615 to be created and viewed. This flattened model effectively opens and unfolds the lumen and presents the lumen interior as a flattened topological map in which features of the surface can be readily observed and marked. It is also known that virtual endoscopy can provide for computer aided diagnostic (CAD) tools 620. CAD tools can include features such as automated polyp detection and classification, stenosis analysis, stent modeling and the like. Further, virtual endoscopy systems also provide measurement tools 625 that allow a user to make and record measurements in the virtual models, such as length, width, area and volume of suspicious region. It will be appreciated that the description of virtual endoscopy features and tools in blocks 605 through 625 is merely illustrative of features and tools available in such systems and is intended as merely illustrative, not limiting. Indeed, it is expected that nearly all features available in virtual endoscopy systems can be beneficially integrated into the present virtually enhanced endoscopy systems and methods.

FIG. 6 also illustrates the acquisition of optical endoscopy image data 630 on the optical image domain. The endoscopy image data can be live video data provided in real-time or near real-time, e.g. data representing a current position of an endoscope during an ongoing procedure, or the endoscopy image data can be in the form stored video of a previously performed procedure. The optical endoscopy image data can be processed 635 to remove distortion (such as reducing the radial distortion introduced by a fish eye lens), adjust image quality and the like. In addition, the present computational endoscope provides for one or more shape from feature processes which are used to generate a model of the surface being observed during the endoscopy procedure. This model can be used, independently or in cooperation with a correlation path, to correlate the optical endoscopy image domain with the virtual endoscopy models in the scan data domain. Further, certain computational endoscopes further include measurement tools 645 which can be used to measure distances and the like.

A user interface 650, such as graphical user interface having multiple display windows, is well suited for managing and cooperatively merging the useful features of a virtual endoscopy system and optical endoscopy system to arrive at a virtually enhanced endoscopy system. In addition to having display windows that can be used to display and manipulate the various features of these systems, the user interface also allows for manual input of data and comments, such as findings and comments of the user, book marks of suspicious areas, and the like.

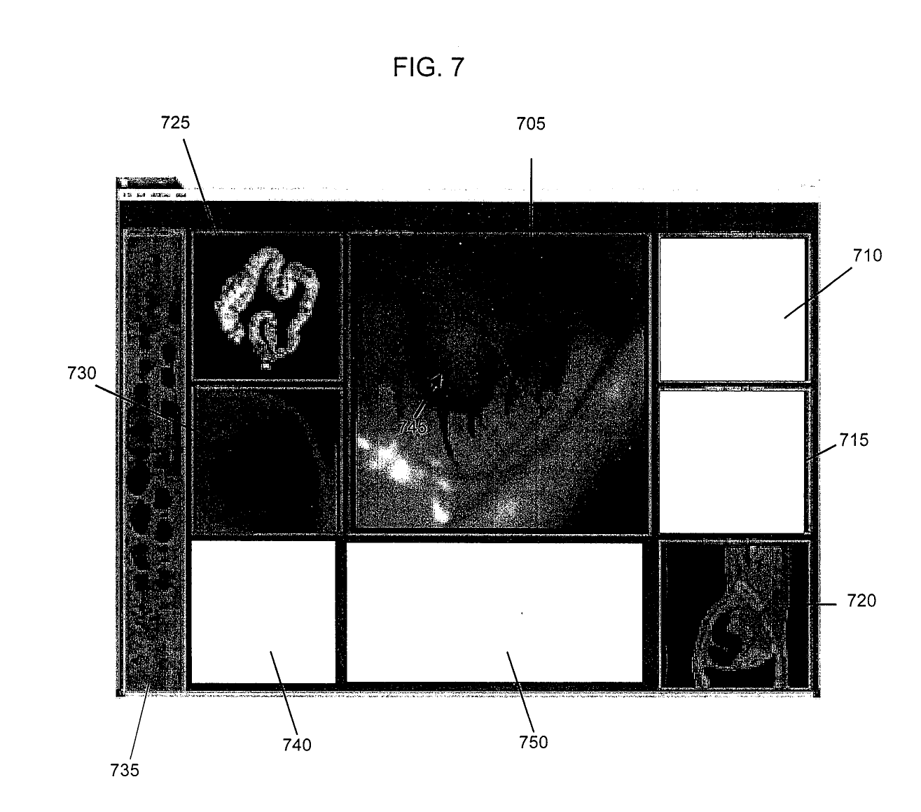

FIG. 7 is a diagram illustrating features of a graphical user interface (GUI) suitable for use with a virtually enhanced endoscopy system. Such a graphical user interface could be presented on one or more display terminals, such as display terminal 217 (FIG. 2). It will be appreciated that although the GUI of FIG. 7 is illustrated as a single display partitioned with multiple windows, multiple physical display units may be used to present various windows of information. It will be further appreciated that the specific windows illustrated, as well as the size and arrangement of the windows, can be dynamically configured by the user and, therefore, FIG. 7 is intended to be merely illustrative of the cooperation of a subset of features of the system.

Referring to FIG. 7, there is a main display window 705. This display window 705 can provide any of unprocessed optical endoscopy images, processed optical endoscopy images or virtual endoscopy images, or combinations and fusions thereof, such as in virtual reality, as selected by the user. In addition to the image presented in the main display window 705, a number of secondary display windows 710, 715, 720, 725, 730, 740 can also be presented to the user. Preferably, the information in the secondary display windows is correlated to the information presented in the main display window 705. The secondary display windows can present various images associated with the image displayed in the main display window 705. For example, assume that the main display window 705 presents images from an optical endoscopy procedure, and in particular video images of suspicious region 745. Secondary display windows can be presented to enhance the information provided by this image. For example, window 710 can display available image processing tools to adjust the image quality observed in the main window, such as providing “thumbwheels” or slide controls (adjustable with a pointing device such as a mouse) to alter the image processing parameters. Such controls can include undistortion parameters, contrast, brightness and the like. Secondary window 715 can include image data archived from one or more previous endoscopy procedures, if available, for the user to make visual comparisons from one time period to another. This allows monitoring of a condition over time. Display window 720 can provide a 2D cross section of the patient developed from the scan data, thereby providing a frame of reference for the current endoscope position. For example, sagittal, coronal or transverse slice images derived from the scan data can be displayed.

Secondary windows 725, 730, 735 and 740 further illustrate examples of the use of virtual endoscopy features in cooperation with the optical endoscopy display. For example, secondary window 725 illustrates a 3D virtual lumen model. The 3D virtual lumen model can indicate the current endoscope position being observed and can also include indicia for various suspicious regions identified in the virtual model using processing techniques, such as CAD. This model can alert the endoscopist of regions of interest that warrant further examination, for example. In addition, as an optical endoscopy proceeds, the 3D colon model in window 725 can identify those regions that have been displayed in the optical colonoscopy window and can highlight those regions that have not been displayed. In the case where the optical endoscopy procedure is being performed live (as opposed to post-procedure analysis of video), when a user is in a region that includes unobserved areas, the secondary window 725 can display these regions, preferably in real time, and alert the user that the endoscope may require flexing or repositioning in order to observe part of the lumen. The alert can be visual, such as highlighting an unviewed portion on the display, audible, or a combination thereof.

In the event that a portion of the lumen cannot be adequately observed with the optical endoscope, or was not viewed in video images from a previous endoscopy being reviewed, the user can revert to the virtual lumen model and perform an examination of those unobserved areas to approach complete lumen inspection. In this case, the virtual endoscopy model can be presented in the main window 705 and the optical endoscopy image presented in a secondary display window during this portion of the examination or the images can be fused in a single window.

In addition to observing a suspicious region in main display window 705, a user can also observe a cross sectional view of the region in secondary window 730 using virtual endoscopy tools. For example, secondary window 730 can present a cross-sectional view of suspicious region 745 being displayed on the main window 705. Further, virtual examination and analysis of a suspicious region 745 can be performed using CAD tools in secondary window 740, such as by performing a virtual biopsy of the region. This provides the user with the ability to determine the composition of the suspicious region being viewed during an optical endoscopy procedure. Window 735 can display a flattened lumen model which presents the entire lumen surface in a planar form and can readily identify regions of interest to the user, such as presenting these regions in a different color. In the context of virtual endoscopy, the flattened lumen model has proven useful in quickly identifying and book marking suspicious regions on a lumen surface. Such benefits can equally be applied in the context of virtually enhanced endoscopy.

Secondary window 750 can include a display of prior findings and observations recorded by a user, a scratch pad for recording notes about the region currently being displayed, book mark information from the virtual endoscopy examination and the like. In addition, while not shown, the system of FIG. 2 can include a microphone and suitable audio processing circuitry to create a digital audio file, such as a WAV file, that can be created while conducting the examination and stored with other examination results as part of a comprehensive patient history database record.

The present system and user interface not only displays and merges the individual features of the virtual endoscopy system and optical endoscopy system in a correlated manner, but can provide a synergistic combination that improves the overall performance of each system. For example, a virtual endoscopy model can be used to identify areas at risk of being missed during optical endoscopy and visual cues can be provided to a person performing the endoscopy procedure, such as to flex the endoscope in a certain manner to effectively conduct the endoscopy examination. Similarly, the virtual endoscopy model can be used to identify suspicious regions, create “bookmarks” for suspicious regions, track the optical endoscopy examination and provide a display that provides that each of the suspicious regions are subjected to examination during the optical colonoscopy procedure. This is expected to improve the coverage area of optical endoscopy from a rate of approximately 77% of the lumen surface to greater than 90% of the lumen surface. Further, the endoscopist can use both the optical image from the endoscopic view and computer aided diagnostics available in the virtual endoscopy model, such as virtual measurement and/or biopsy, to improve the identification and analysis of potentially cancerous polyps.

The overlaying of the tools available in the scan data domain with the images from the optical endoscopy domain also provides the endoscopist with greater flexibility in available viewing options. For example, in addition to the actual optical endoscopy view, the endoscopist can simultaneously, or sequentially, view a flattened view of the lumen, a 3D rendering of the lumen, and cross sectional views of the lumen, generated from the virtual endoscopy model. During the examination, the user can record findings associated with the examination, including providing notes associated with specific regions in the examination, such as by associating notes with bookmarks identified in the virtual examination, optical examination or both. When examining a region for which notes have been previously recorded, a visual cue can be provided on the relevant windows indicating that additional information is available.

Although certain embodiments have been disclosed and described herein, it will be understood by those skilled in the art that various changes in such embodiments can be made thereto without departing from the spirit and scope of the invention as defined in the appended claims.

What is claimed is:

1. A method of virtually augmented endoscopy comprising:
receiving scan data of a region;
generating a virtual representation of at least a portion of a lumen within the region from the scan data;
receiving optical endoscopy image data from within said lumen;
generating a correlation between the image data and the scan data of the region;
displaying an image generated from the image data in correlation with the virtual representation of the lumen.

2. The method of virtually augmented endoscopy of claim 1, wherein generating a correlation further comprises generating a correlation path in the virtual representation of the lumen from the scan data.

3. The method of virtually augmented endoscopy of claim 2, wherein the correlation path is a hugging corner path through the lumen.

4. The method of virtually augmented endoscopy of claim 1 wherein the generating a correlation further comprises generating a correlation model between the virtual scan data and the image data.

5. The method of virtually augmented endoscopy of claim 4, wherein the correlation model includes generating a shape from feature model from the image data.

6. The method of virtually augmented endoscopy of claim 5, wherein the feature is motion and the model is generated using a shape from motion modeling process.

7. The method of virtually augmented endoscopy of claim 5, wherein the feature is shading and the model is generated using a shape from shading modeling process.

8. The method of virtually augmented endoscopy of claim 5, wherein the feature is both motion and shading and the model is generated using a combination of shape from motion and shape from shading modeling processes.

9. The method of virtually augmented endoscopy of claim 1, further comprising performing computer aided diagnostics on the scan data to identify suspicious regions in the virtual representation of the lumen and identifying said suspicious regions in the displaying step.

10. The method of virtually augmented endoscopy of claim 9, wherein the virtual representation of the lumen is a 2D flattened model of the lumen interior and suspicious regions are identified in an image of the 2D flattened model.

11. The method of virtually augmented endoscopy of claim 10, further comprising comparing the virtual lumen model to the image data and identifying regions that were not displayed in the image data.

12. The method of virtually augmented endoscopy of claim 11, further comprising processing of the image data to enhance the quality of the image from the image data.

13. The method of virtually augmented endoscopy of claim 12, wherein the processing of image data includes a process to reduce radial distortion introduced by a fish eye lens.

14. The method of virtually augmented endoscopy of claim 1, wherein the displaying step further comprises generating a plurality of display windows, at least one display window displaying an image generated from the image data, at least one window displaying an image generated from the scan data, and at least one window displaying information entered by a user.

15. The method of virtually augmented endoscopy of claim 1, wherein the displaying step further comprises generating a plurality of display windows, at least a first display window displaying an image generated from the image data, at least a second window displaying an image generated from a computer aided diagnostic procedure for a region corresponding to the image generated from the image data.

16. The method of virtually augmented endoscopy of claim 1, further comprising:
performing computer aided diagnostics on the scan data to generate a list of suspicious regions;
tracking the regions displayed in the displaying step; and
identifying said suspicious regions on the list that were not displayed in the displaying step.

17. The method of virtually augmented endoscopy of claim 15, further comprising providing an indication to a user to manipulate an endoscope to view an unviewed region.

18. A system for virtually enhanced endoscopy, comprising:
an interface receiving scan data of a region;
an interface receive optical image data of a region;
a processor, the processor being configured to process the scan data and generate a virtual representation of at least a portion of a lumen within the region from the scan data, receive the optical image data of a region and apply at least one image processing operation, correlate the optical image data and the scan data, and
a graphical user interface including a display, the graphical user interface receiving display data from the processor for generating a first image from the image data in correlation with a second image from the virtual representation of the lumen.

19. The system for virtually enhanced endoscopy wherein the virtual representation of at least a portion of a lumen includes at least one of a 3D model of a lumen, a flattened model of a lumen, a virtual biopsy, and a 2D image of a portion of a lumen.

20. The system for virtually enhanced endoscopy wherein the processor is configured to:
perform computer aided diagnostics on the scan data to generate a list of suspicious regions;
track the regions displayed on the graphical user interface; and
provide a display identifying said suspicious regions on the list that were not displayed on the graphical user interface in the first image.
